(19) United States
(12) Patent Application Publication
(10) Pub. No.: US 2004/0010952 A1
(43) Pub. Date: Jan. 22, 2004

(54) Decorative or branding affixture of words or figures

(76) Inventor: Ming Chung Chen, Hsinten City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/195,540

(22) Filed: Jul. 16, 2002

(51) Int. Cl. G09F 7/12; G09F 3/10

(52) U.S. Cl. 40/594; 40/638

(57) ABSTRACT

The present invention relates to a decorative or branding affixture of words or figures, which includes a basic layer made of PET, PP, or PE, for being printed with desired words or drawings. An affixed layer of static electricity is coated on the basic layer, which is then capable of being affixed directly on glass of windows or surfaces of other objects to display a celebrating or branding effect.

### BACKGROUND OF THE INVENTION

In some situation, people use decorative affixture, such as paper with certain words or figures, affixed on the wall or windows to show different purposes. The paper affixture is always affixed by gum and is hard to be removed. A known improvement is provided. It is made of PVC included with some medium to become a thin affixture, which can be printed with words or colorful drawings and can affixed on glass of windows or other plane surface directly. Although this known PVC affixture can be fixed on without using gum, it will be hardened that looses the effect of affix during a period of time in use. Moreover, the medium used for manufacturing the PVC affixture is unstable that pollutes our environment. It is known that this PVC affixture can not be efficiently used in high or low temperature.

Accordingly, the primary object of the invention is to provide a decorative or branding affixture of words or figures, which includes a basic layer for printing with any desired words or figures and an affixed layer for affixing on glass or surfaces of other objects easily by static electricity. Now the features and advantages of the present invention will be described in detail with reference to the accompanying drawings.

### BRIEF DESCRIPTION OF ACCOMPANYING DRAWINGS

FIG. 1 is a plan view showing an affixture with decorative figure according to the present invention.

FIG. 2 is a cross-sectional view of FIG. 1.

### DETAILED DESCRIPTION OF PREFERRED EMBODIMENTS

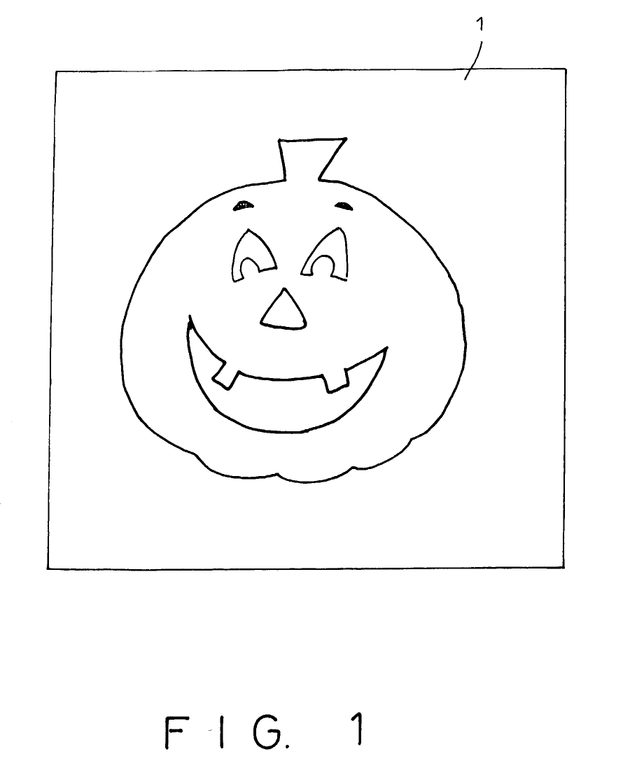

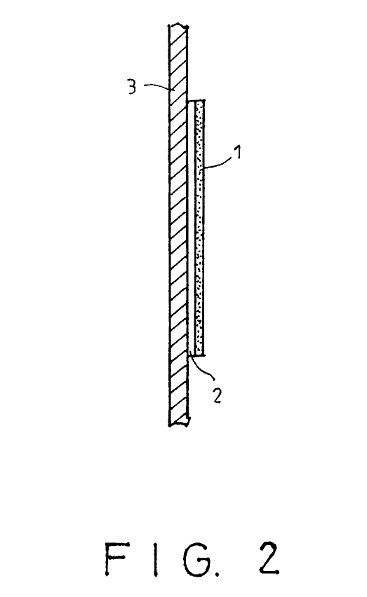

Please refer to FIGS. 1 and 2, the present invention includes a basic layer (1) and an affixed layer (2) of static electricity. The basic layer (1) can be made of some stable plastic material, such as PET, PP, or PE, to become a thin affixture, which can be printed with any desired words or drawings. The affixed layer (2) is coated on the basic layer (1) that provides a strength affixing effect to affix on the glass or the surface of any other object. So the decorative or branding affixture of words or figures can be displayed in ease for obtaining a certain purpose.

Since the affixture according to the present invention uses only the layer of static electricity to affix on, it can be removed without trouble. Furthermore, the basic layer is made of stable plastic material that can be normally used in high or low temperature for a very long time and can avoid from pollution.

It is to be understood that the present invention includes improvement and utility and should be allowed for patent.

What is claimed is:

1. A decorative or branding affixture of words or figures including a basic layer being made of stable plastic material for being printed with words or drawings thereon and an affixed layer coated on the basic layer; and the affixture can be directly affixed on glass or surface of any other object based on the static electricity of the affixed layer for obtaining effect of display.
